(19) United States
(12) Patent Application Publication
(10) Pub. No.: US 2012/0134285 A1
(43) Pub. Date: May 31, 2012

(54) RADIO COMMUNICATION APPRATUS, RADIO COMMUNICATION SYSTEM, AND RADIO COMMUNICATION METHOD IN RADIO COMMUNICATION APPARATUS

(75) Inventor: Naoto MIKAMI, Yokohama (JP)

(73) Assignee: FUJITSU SEMICONDUCTOR LIMITED, Yokohama (JP)

(21) Appl. No.: 13/215,552

(22) Filed: Aug. 23, 2011

(30) Foreign Application Priority Data
Nov. 26, 2010 (JP) 2010-263157

(51) Int. Cl. H04W 24/00

(52) U.S. Cl. 370/252

(57) ABSTRACT

A radio communication apparatus for performing radio communication with an other radio communication apparatus, the radio communication apparatus including: a control unit which determines an encoding rate, a modulation scheme, and data volume for each of a plurality of transmission data transmitted to the other radio communication apparatus based on an error detection result received from the other radio communication apparatus; and a transmission unit which respectively transmits the plurality of transmission data to the other radio communication apparatus based on the determined encoding rate, modulation scheme, and data volume.

### CROSS-REFERENCE TO RELATED APPLICATION

This application is based upon and claims the benefit of priority of the prior Japanese Patent Application No. 2010-263157, filed on Nov. 26, 2010, the entire contents of which are incorporated herein by reference.

### FIELD

The embodiments discussed herein are related to a radio communication apparatus, a radio communication system, and a radio communication method in a radio communication apparatus.

### BACKGROUND

Radio communication systems such as cell phone systems and radio local area networks (LAN) are currently used widely. In addition, in the field of radio communication, active discussions are continuing to be carried out regarding next-generation radio communication technologies to further improve communication speed and communication capacity.

One example of these radio communication technologies is hybrid automatic repeat request (HARQ) technology. HARQ is a technology that combines, for example, automatic repeat request (ARQ) and forward error correction (FEC) technologies.

FIG. 16 illustrates a sequence example in the case of HARQ being applied between a base station apparatus (to be simply referred to as a “base station”) 150 and a terminal apparatus (to be simply referred to as a “terminal”) 250.

The base station 150 transmits a Data A and an error detection code (such as a cyclic redundancy check (CRC)) to the terminal 250 (S101), and the terminal 250 determines whether or not there is an error in the Data A using the error detection code. When there has been determined to an error in the received Data A as a result thereof, the terminal 250 transmits a negative acknowledgment (such as an NACK signal) to the base station 150 indicating that the detection result has yielded the presence of an error (S102). At this time, the terminal 250 retains the Data A for which there has been determined to be an error.

The base station 150, upon receiving an NACK signal, retransmits the Data A to the terminal 250 (S104). The terminal 250 combines the retransmitted Data A and the retained Data A and determines whether or not an error is present in the combined Data A (S105). As a result, in the case the Data A is determined to be free of error, the terminal 250 transmits a positive acknowledgment (such as an ACK signal) to the base station 150 (S106). In the case the Data A is still determined to be in error, the terminal 250 again transmits an NACK signal and repeats retransmission of the Data A to the base station 150. On the other hand, in the case a positive acknowledgment has been received, the base station 150 transmits a Data B to the terminal 250.

The number of times the terminal 250 transmits an NACK signal in order to determine the presence of an error using combined data can be reduced in comparison with the case of not applying HARQ. In addition, the number of times the base station 150 retransmits data can also be reduced in comparison with not applying HARQ. Thus, radio communication systems employing HARQ are able to improve throughput even in cases in which the environment of the communication channels is not satisfactory.

In the case HARQ is applied, the base station 150 transmits a single burst data, for example, to the terminal 250 while adding a single error detection code. The burst data is, for example, one unit to which the error detection code is added, and 2 to 6 burst data are present in a single radio frame. The terminal 250 transmits error detection results indicating the presence or absence of an error to the base station 150 using this error detection code.

The base station 150 select, for example, a combination of a modulation scheme and an encoding rate (to be referred to as a modulation and coding scheme (MCS)) that is most successfully transmitted to the terminal 250 based on the results of error detection. In this case, for example, the base station 150 transmits burst data after selecting a different MCS for each user (or terminal) by assigning one or a plurality of burst data to a single user (or terminal). Thus, if radio resources are assigned to multiple users within a single radio frame, the base station 150 transmits burst data according to a plurality of different MCS for each user.

In addition, the base station 150 may also change the MCS that has been selected and used according to the results of error detection. In this case, the base station 150 transmits burst data after changing the MCS for each user with the exception of data retransmitted by HARQ. (For example, refer to Japanese Laid-Open Patent Publication Nos. 2004-253828, 2006-115357, and 2007-228488.)

However, when the base station 150 changes the MCS, since one or all of a plurality of burst data assigned to each user also changes, there are cases in which the probability of an error in burst data after changing the MCS becomes higher in comparison with before changing the MCS.

For example, if it is assumed that the error rate of a single bit is the bit error rate (BER), the error rate of burst data is the packet error rate (PER), n bits are contained in a single burst data, and a random error occurs in each bit, then the following formula becomes valid.

[Formula 1]

PER=1−(1−BER)ⁿ (1)

On the basis of the above formula, PER increases as the number of bits contained in a single burst data increases. Accordingly, the probability of error increases as the amount of burst data for which MCS has been changed increases. Since the number of retransmissions increases in comparison with that prior to changing the MCS as the probability of error increases, the result is a decrease in throughput as compared with prior to changing MCS.

On the other hand, selection of MCS so that the error rate becomes “0” does not necessarily result in efficient data transmission. FIG. 17 illustrates an example of the relationship between MCS and the number of bits able to be transferred with a single subcarrier. For example, in a case where a modulation scheme is QPSK, the number of bits that can be transferred is “2.” When the encoding rate is “½”, the number of transferred bits becomes “1”. In FIG. 17, the column indicating the “no. of transferred bits” contains values resulting from multiplying the encoding rate by the number of bits able to be transferred with a single subcarrier in each modulation scheme.

Here, when, for example, the error rate is “0” for an MCS of “64QAM ½”, the number of transferred bits becomes 3.0×1 (=100%)=3.0. On the other hand, when the error rate is “20%” for an MCS of “64QAM ⅔”, the number of transferred bits becomes 4.0×0.8=3.2 bits. In the relationship between MCS and error rate, the latter results in improvement of throughput. The described documents is not discussed the relationship between MCS and error rate, and accordingly there are cases in which throughput is not attempted to be improved according to the selected MCS.

### SUMMARY

According to an aspect of the invention, a radio communication apparatus for performing radio communication with an other radio communication apparatus, the radio communication apparatus including: a control unit which determines an encoding rate, a modulation scheme, and data volume for each of a plurality of transmission data transmitted to the other radio communication apparatus based on an error detection result received from the other radio communication apparatus; and a transmission unit which respectively transmits the plurality of transmission data to the other radio communication apparatus based on the determined encoding rate, modulation scheme, and data volume.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of the configuration of a radio communication system;

FIG. 2 illustrates an example of the configuration of a radio communication system;

FIG. 3 illustrates an example of the configuration of a base station apparatus;

FIG. 4 illustrates an example of the configuration of a terminal apparatus;

FIGS. 5A and 5B illustrate an example of a radio frame and an example of burst data, respectively;

FIG. 6 illustrates a flow chart indicating an example of the operation of burst size determination processing;

FIG. 7 illustrates a flow chart indicating an example of the operation of burst size determination processing;

FIGS. 8A to 8G respectively illustrate examples of burst size;

FIGS. 9A to 9E respectively illustrate examples of burst size;

FIG. 10 illustrates a flow chart indicating an example of the operation of internal error assessment processing;

FIG. 11 illustrates a flow chart indicating an example of the operation of burst size determination processing;

FIG. 12 illustrates a flow chart indicating an example of the operation of MCS selection processing;

FIGS. 13A and 13B respectively illustrate examples of the configuration of a radio communication system;

FIG. 14 illustrates an example of another configuration of a base station apparatus;

FIG. 15 illustrates an example of another configuration of a terminal apparatus;

FIG. 16 illustrates a sequence example in the case of applying HARQ; and

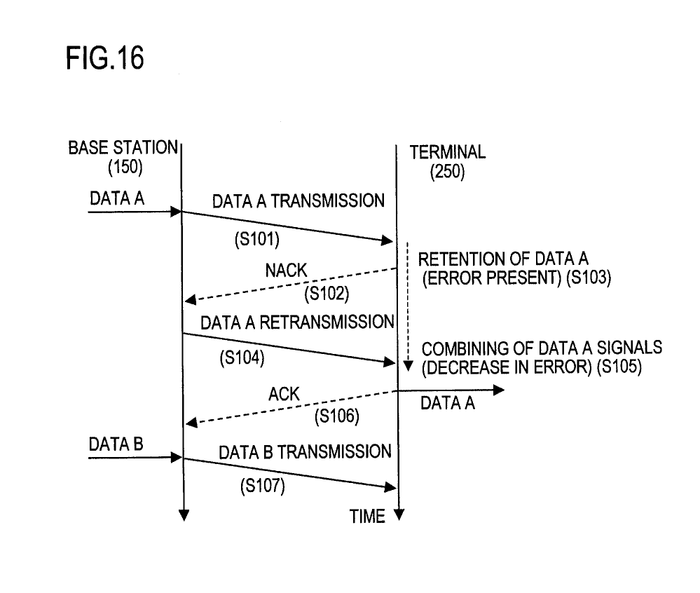

FIG. 17 illustrates an example of the correlation between MCS and the number of transferred bits.

### DESCRIPTION OF EMBODIMENTS

The following provides an explanation of embodiments of the present invention.

### First Embodiment

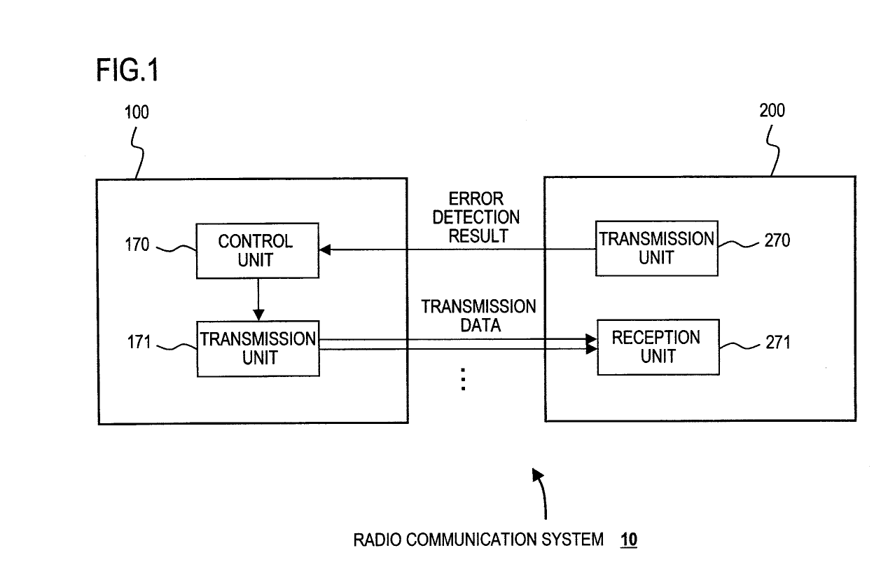

First, an explanation is provided of a first embodiment. FIG. 1 illustrates an example of the configuration of a radio communication system 10 of the first embodiment. The radio communication system 10 is provided with a first radio communication apparatus 100 and a second radio communication apparatus 200. Radio communication is carried out between the first radio communication apparatus 100 and the second radio communication apparatus 200.

The first radio communication apparatus 100 is provided with a control unit 170 and a transmission unit 171. The control unit 170 determines an encoding rate, modulation scheme and data volume for each of a plurality of transmission data transmitted to the second radio communication apparatus 200 based on an error detection result received from the second radio communication apparatus 200. The transmission unit 171 transmits the plurality of transmission data to the second radio communication apparatus 200 based on the determined encoding rate, modulation scheme and data volume.

The second radio communication apparatus 200 is provided with a transmission unit 270 and a reception unit 271. The transmission unit 270 transmits an error detection result to the first radio communication apparatus 100. In addition, the reception unit 271 receives a plurality of transmission data transmitted from the first radio communication apparatus 100.

The control unit 170 individually determines and transmits an encoding rate, modulation scheme and data volume for each of the plurality of transmission data based on an error detection result. Thus, in comparison with the case of transmitting all of the plurality of transmission data according to the same encoding rate and modulation scheme by changing the encoding rate and modulation scheme, for example, the probability of a negative acknowledgment being transmitted from the second radio communication apparatus 200 is lower for the present radio communication system 10. Accordingly, the number of times transmission data is retransmitted from the first radio communication apparatus 100 is less than that in the above case, and throughput of the present radio communication system 10 is improved.

In addition, since the control unit 170 also determines the data volume along with the encoding rate and the like for each of the plurality of transmission data, in comparison with the case of transmitting all of the plurality of transmission data according to the same encoding rate and the like, the probability of a negative acknowledgment being transmitted from the second radio communication apparatus 200 is lower for the present radio communication system 10. Accordingly, the present radio communication system 10 is able to improve throughput.

Furthermore, in FIG. 1, the first radio communication apparatus 100 can be a radio communication apparatus, and the second radio communication apparatus 200 can be another radio communication apparatus.

### Second Embodiment

<Example of Overall Configuration>

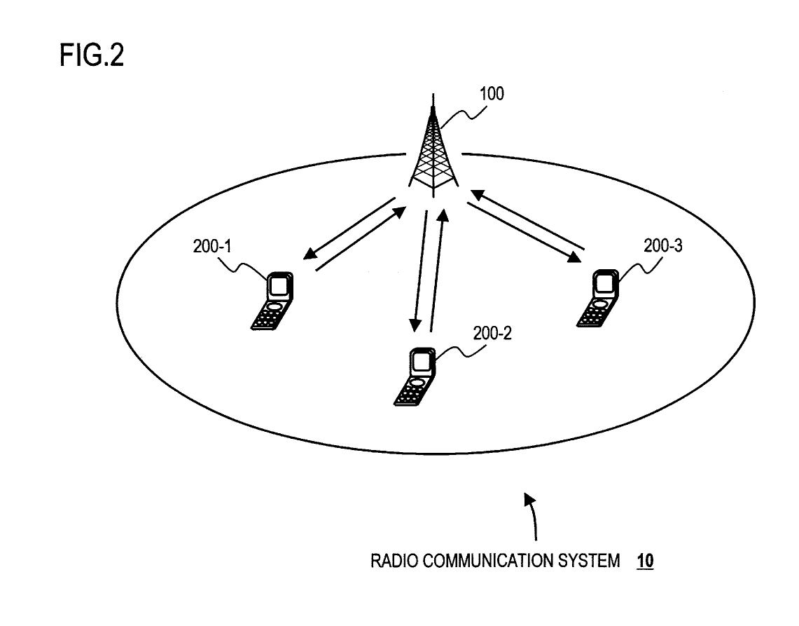

Next, an explanation is provided of a second embodiment. FIG. 2 illustrates an example of the configuration of the radio communication system 10 of the present second embodiment. The radio communication system 10 is provided with a base station 100 and terminals 200-1 to 200-3.

The base station 100 has one or a plurality of cells, and various services such as voice calling or video streaming are provided through radio communication with the terminals 200-1 to 200-3 within the range of each cell. In addition, the base station 100 is capable of parallel radio communication with the plurality of terminals 200-1 to 200-3. On the other hand, the terminals 200-1 to 200-3 carry out radio communication by connecting with the base station 100. The terminals 200-1 to 200-3 are, for example, cell phones or portable information terminals. Furthermore, the terminals 200-1 to 200-3 may be a single terminal or a plurality of terminals.

The base station 100 and the terminals 200-1 to 200-3 are capable of two-way radio communication. Namely, the base station 100 can transmit data and signals to the terminals 200-1 to 200-3 (downlink communications), while the terminals 200-1 to 200-3 can transmit data and signals to the base station 100 (uplink communications). The base station 100 carries out radio communication by scheduling uplink communications and downlink communications and assigning radio resources. Scheduling information that indicates the results of scheduling is suitably transmitted from the base station 100 to the terminals 200-1 to 200-3 in the form of a control signal, for example.

<Configuration Example of Base Station 100 and Terminal 200>

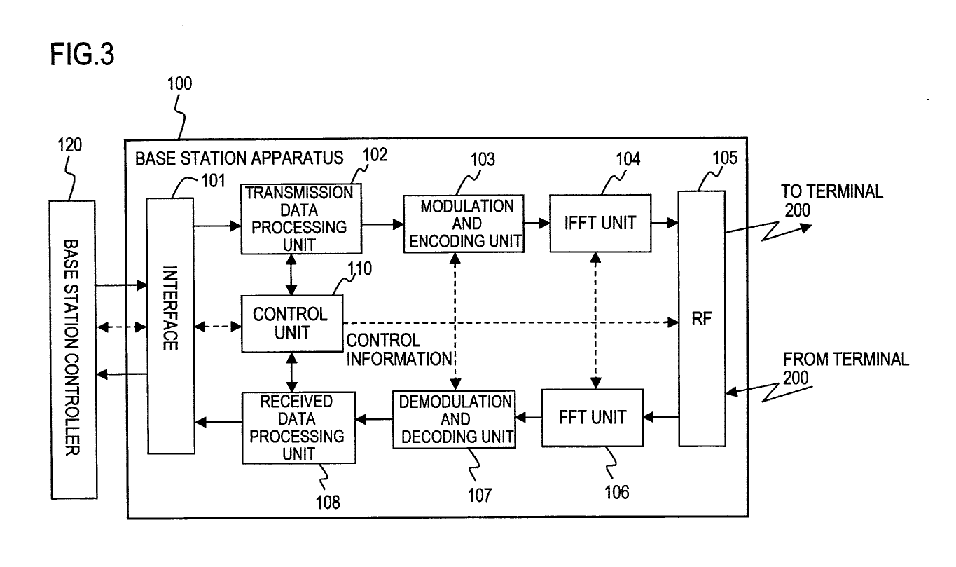

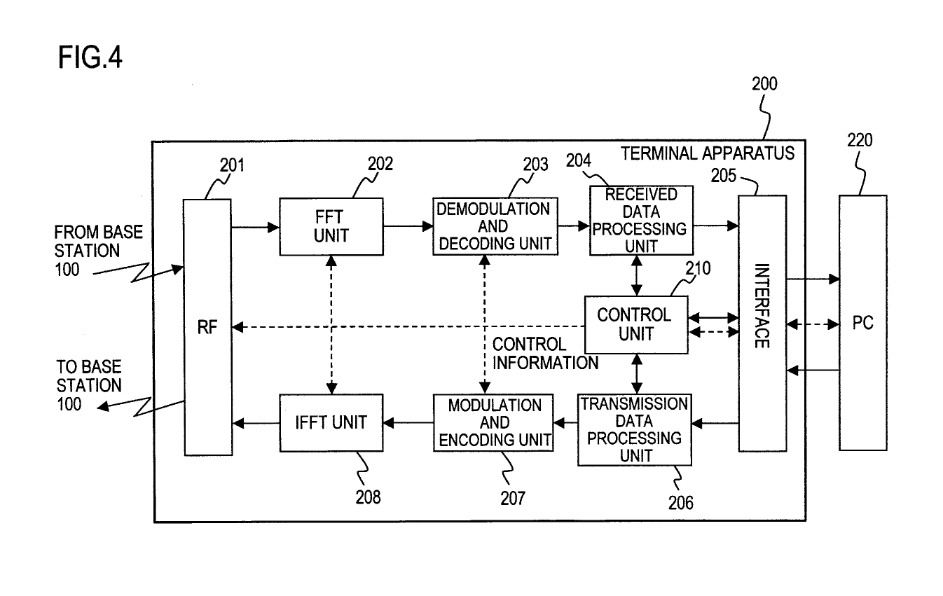

Next, an explanation is provided of examples of each of the configurations of the base station 100 and the terminals 200-1 to 200-3 in the second embodiment. FIG. 3 illustrates an example of the configuration of the base station 100, while FIG. 4 illustrates an example of each of the configurations of the terminal 200 (the terminals 200-1 to 200-3 are referred to as the terminal 200 unless indicated otherwise).

The base station 100 is provided with an interface unit 101, a transmission data processing unit 102, a modulation and encoding unit 103, an inverse fast Fourier transform (IFFT) unit 104, a radio frequency (RF) unit 105, a fast Fourier transform (FFT) unit 106, a demodulation and decoding unit 107, a received data processing unit 108 and a control unit 110. Furthermore, the base station 100 is connected to a base station controller 120, and transmission or reception of user data (to be simply referred to as “data”) and control information is carried out between the base station 100 and the base station controller 120.

Furthermore, the control unit 170 of the first embodiment corresponds to, for example, the control unit 110, and the transmission unit 171 of the first embodiment corresponds to, for example, the transmission data processing unit 102, the modulating and encoding unit 103, the IFFT unit 104 and the RF unit 105.

The interface unit 101 fulfills the role of an interface between the base station 100 and the base station controller 120. The interface unit 101 converts, for example, data transmitted from the base station controller 120 (solid lines in FIG. 3) or control information (dotted lines) to data or control information of a format able to be processed in the base station 100. The interface unit 101 respectively outputs converted data to the transmission data processing unit 102 and converted control information to the control unit 110. In addition, the interface unit 101 converts data or control information processed in the base station 100 to data or control information of a format that can be transmitted to the base station controller 120. The interface unit 101 transmits the converted data or control information to the base station controller 120.

Furthermore, examples of control information transmitted from the base station controller 120 include initial set values for the control unit 110 and various parameter values relating to radio transmission. In addition, examples of control information transmitted to the base station controller 120 include values relating to MCS set by the control unit 110 and parameter values relating to handover.

The transmission data processing unit 102 carries out processing such as outputting data equivalent to a single radio frame on data output from the interface unit 101 under control of the control unit 110. Consequently, the transmission data processing unit 102 is provided with, for example, a buffer for retaining data equivalent to a single radio frame. The transmission data processing unit 102 outputs data equivalent to a single radio frame, for example, to the control unit 110.

The modulation and encoding unit 103 carries out encoding processing on transmission data output from the transmission data processing unit 102 based on control information output from the control unit 110, and subsequently carries out modulation processing on that data. The encoding processing is, for example, error correction encoding processing such as turbo encoding or BCH encoding. Furthermore, encoding rate is also referred to as the error correction encoding rate, and is the ratio of the number of bits following error correction encoding processing to the number of information bits. Modulation processing is processing in which the frequency, phase or amplitude of a carrier wave (carrier) is changed corresponding to a source signal, examples of which include quadrature phase shift keying (QPSK) and quadrature amplitude modulation (64QAM). The modulation and encoding unit 103 adds, for example, an error detection signal (or a redundancy code or error detection data) to transmission data following modulation. Examples of error detection signals include a parity bit and a CRC code. Furthermore, information relating to MCS is included in control information output from the control unit 110.

The IFFT unit 104 converts frequency axis data and the like to time axis data and the like by carrying out IFFT conversion on, for example, data output from the modulation and encoding unit 103. The IFFT unit 104 outputs the converted data and the like to the RF unit 105.

The RF unit 105 converts data and the like output from the IFFT unit 104 to a radio signal by frequency conversion and the like. The RF unit 105 is provided with, for example, a frequency converter or band-pass filter for converting to radio signals. Data converted to radio signals by the RF unit 105 is transmitted to the terminal 200 via an antenna (not illustrated) as a radio signal. In addition, the RF unit 105 receives radio signals transmitted from the terminal 200 via an antenna, carries out frequency conversion on the received radio signals, and outputs the frequency-converted radio signals to the FFT unit 106.

The FFT unit 106 converts data or signals output from the RF unit 105 from time axis data to frequency axis data and the like.

The demodulation and decoding unit 107 carries out demodulation processing based on control information from the control unit 110, and subsequently carries out decoding processing. Demodulation processing refers to processing in which received data or received signals are extracted from a carrier wave (carrier), for example. In addition, decoding processing refers to, for example, error correction decoding processing, and in the case of turbo decoding, decoding is carried out by repeatedly calculating, for example, a likelihood ratio (log-likelihood ratio: LLR) indicating the probability ratio of an information bit being “0” or “1”. Furthermore, information indicating the methods used for decoding processing and demodulation processing is included in control information output from the control unit 110.

The received data processing unit 108 carries out processing of various types of data such as resolving the configuration of a single radio frame on data and signals output from the demodulation and decoding unit 107 for each radio frame. The received data processing unit 108 outputs received data to the interface unit 101, and outputs an error detection result (ACK signal or NACK signal) to the control unit 110.

The control unit 110 carries out control on the transmission data processing unit 102 and the received data processing unit 108, as well as the modulation and encoding unit 103, the demodulation and decoding unit 107, the IFFT unit 104 and the FFT unit 106. Consequently, the control unit 110 outputs, for example, control information including MCS to the modulation and encoding unit 103 and the demodulation and decoding unit 107, and outputs control information including frequency settings, output power values and the like to the IFFT unit 104, the RF unit 105 and the FFT unit 106.

In addition, the control unit 110 carries out assignment (or scheduling) of radio resources for downlink communications and uplink communications based on transmission data output from the transmission data processing unit 102. The control unit 110 is able to output the assignment results (or scheduling results) to the modulation and encoding unit 103 and the demodulation and decoding unit 107 as control information, for example.

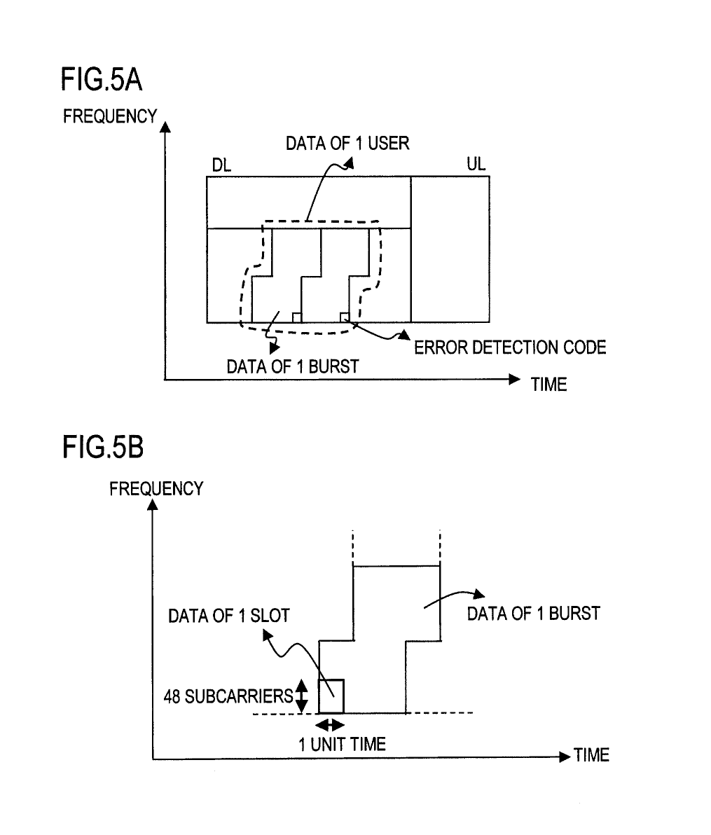

FIG. 5A illustrates an example of assignment of radio resources in a single radio frame. In FIG. 5A, a time axis is indicated on the horizontal axis, while a frequency axis is indicated on the vertical axis. As illustrated in FIG. 5A, a single radio frame is divided into a downlink (DL) radio resources and uplink (UL) radio resources. In the example of FIG. 5A, the control unit 110 is illustrated to be assigning two burst data to a certain user (or terminal 200) during downlink communications. The burst data is a single unit to which is added an error detection code and the like. In the example illustrated in FIG. 5A, a CRC is added as an example of an error detection code. Furthermore, 2 to 4 burst data, for example, are assigned to a single user per radio frame.

FIG. 5B illustrates an example of a single burst data in a radio frame. The single burst data includes a plurality of slots. A single slot is a single unit of radio resources indicated by, for example, a rectangle of “48 subcarriers” in the direction of the frequency axis during a unit time in the direction of the time axis.

Returning to FIG. 3, the control unit 110 determines an MCS based on an error detection result, for example, changes the size of the burst data to be assigned to the MCS (or the amount of burst data, to be referred to as “burst size”), and determines the burst size included in each MCS. The control unit 110 changes the burst size in slot units, for example. The details thereof will be subsequently described. Furthermore, the control unit 110 outputs the determined MCS and burst size to the modulation and encoding unit 103. Alternatively, the control unit 110 is also able to output the determined burst size to the transmission data processing unit 102 and output the determined MCS to the modulation and encoding unit 103.

Next, an explanation is provided of an example of the configuration of the terminal 200. The terminal 200 is provided with an RF unit 201, an FFT unit 202, a demodulation and decoding unit 203, a received data processing unit 204, an interface unit 205, a transmission data processing unit 206, a modulation and encoding unit 207, an IFFT unit 208 and a control unit 210. Furthermore, the terminal 200 is wire-connected to a personal computer (to be abbreviated as “PC”) 220, for example.

Furthermore, the transmission unit 270 of the first embodiment corresponds to, for example, the demodulation and decoding unit 203, the received data processing unit 204, the control unit 210, the transmission data processing unit 206, the modulation and encoding unit 207, the IFFT unit 208 and the RF unit 201. In addition, the reception unit 271 of the first embodiment corresponds to, for example, the RF unit 201, the FFT unit 202, the demodulation and decoding unit 203, the received data processing unit 204 and the control unit 210.

The RF unit 201 receives radio signals transmitted from the base station 100 via an antenna (not illustrated), carries out frequency conversion and the like on the signals, and outputs the converted signals to the FFT unit 202. In addition, the RF unit 201 converts data and signals output from the IFFT unit 208 to radio signals by carrying out frequency conversion and the like, and transmits the converted signals to the base station 100 via an antenna. The RF unit 201 is provided with a frequency converter or band-pass filter and the like in order to carry out frequency conversion and the like.

The FFT unit 202 converts time axis data and the like to frequency axis data and the like by carrying out FFT conversion on data and signals output from the RF unit 201.

The demodulation and decoding unit 203 carries out demodulation processing on data and signals output from the FFT unit 202, and subsequently carries out decoding processing. The methods used for demodulation processing and decoding processing by the demodulation and decoding unit 203 are included in a control signal transmitted from the base station 100, the control signal is output from the demodulation and decoding unit 203 to the control unit 210, and is output to the demodulation and decoding unit 203 in the form of control information in the control unit 210. The demodulation and decoding unit 203 carries out demodulation processing and decoding processing based on the control information.

In addition, the demodulation and decoding unit 203 carries out an error detection operation based on an error detection code added to a reference signal or data and the like transmitted from the base station 100, and outputs an error detection result that indicates the presence or absence of an error. In the case the error detection code is a parity bit, for example, error detection is carried out according to whether or not the even and odd numbers of data bits “1” and “0” agree with values indicated in the parity bit. In addition, in the case the error detection code is a CRC code, error detection is carried out using a characteristic polynomial. Regardless of the calculation method, in the case of comparing retransmitted data, for example, a combination is used consisting of erroneous data received prior to retransmission and the retransmitted data. The demodulation and decoding unit 203 is provided with, for example, a buffer for retaining data.

The received data processing unit 204 carries out various types of processing such as outputting data output from the demodulation and decoding unit 203 in single radio frame units so as to become constant continuous data. Consequently, the received data processing unit 204 is provided with a buffer, for example. In addition, the received data processing unit 204 outputs the error detection result output from the demodulation and decoding unit 203 to the control unit 210, and outputs received data to the interface unit 205.

The interface unit 205 fulfills the role of an interface between the terminal 200 and the PC 220. The interface unit 205 converts received data and control information output from the received data processing unit 204 and the control unit 210, for example, to a format able to be output to the PC 220, and then transmits that data and information to the PC 220. In addition, the interface unit 205 converts data and control information output from the PC 220, for example, to a format able to be processed within the terminal 200, and then outputs that data and information to the control unit 210 and the transmission data processing unit 206. Examples of control information output from the PC 220 to the control unit 210 include various types of set values such as initial set values for the control unit 210, and various set values or MCS set by the control unit 210 as control information output from the control unit 210 to the PC 220.

The transmission data processing unit 206 carries out processing on various types of data, such as processing that outputs data output from the interface unit 205 as data equivalent to a single radio frame. Consequently, the transmission data processing unit 206 is provided with a buffer, for example.

The modulation and encoding unit 207 carries out encoding processing on data output from the transmission data processing unit 206, and subsequently carries out modulation processing. Although the modulation processing and the encoding processing are carried out based on an MCS included in control information output from the control unit 210, the MCS is generated and transmitted in the base station 100 in the form of a control signal.

The IFFT unit 208 converts frequency axis data and the like to time axis data and the like by carrying out IFFT conversion on data and signals following modulation and encoding processing. The IFFT unit 208 outputs the converted data and the like to the RF unit 201.

The control unit 210 causes the RF unit 201, the FFT unit 202 and the IFFT unit 208 to carry out various types of processing such as frequency conversion by outputting control information including frequency, output power and the like. In addition, the control unit 210 causes the demodulation and decoding unit 203 and the modulation and encoding unit 207 to carry out various types of processing such as demodulation processing by outputting control information including an MCS. Moreover, when an error detection result calculated by the demodulation and decoding unit 203 is input via the received data processing unit 204, the control unit 210 instructs the transmission data processing unit 206 to transmit the error detection result to the base station 100. For example, when an error detection result has been obtained that indicates the absence of error, the control unit 210 instructs the transmission data processing unit 206 so transmit an ACK signal as a positive acknowledgment, and when a detection result has been obtained that indicates the presence of an error, the control unit 210 instructs the transmission data processing unit 206 to transmit an NACK signal as a negative acknowledgment. As a result, an error detection result (such as an ACK signal or NACK signal) is generated in the transmission data processing unit 206, modulation processing and the like is carried out by the modulation and encoding unit 207, and the error detection result is converted to a time axis signal by the IFFT unit 208 and transmitted to the base station 100 via the RF unit 201.

### Operation Example

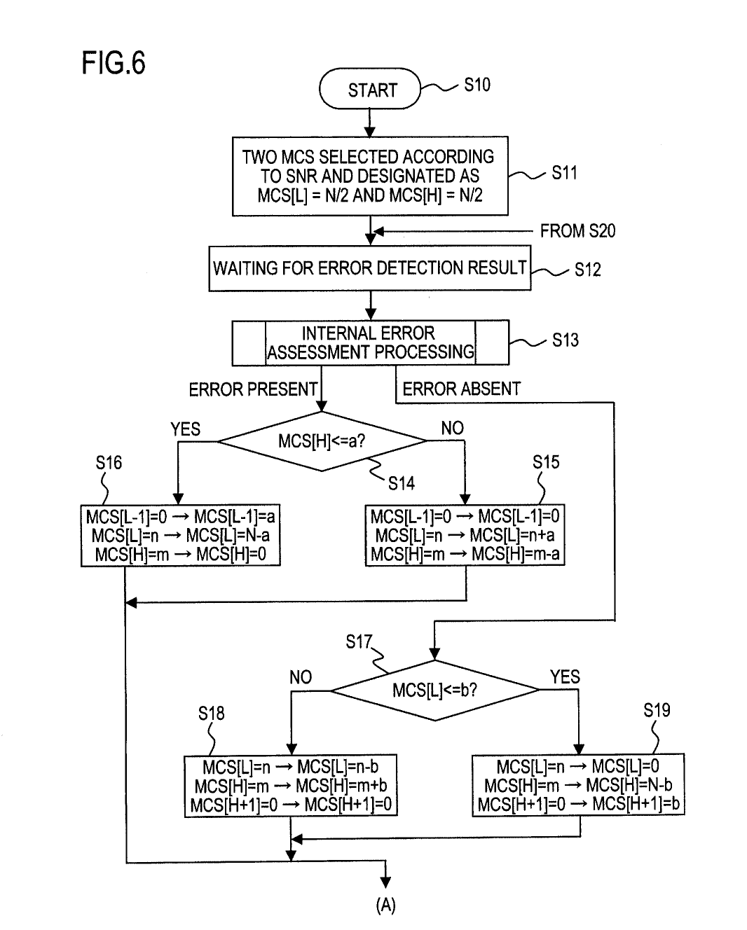

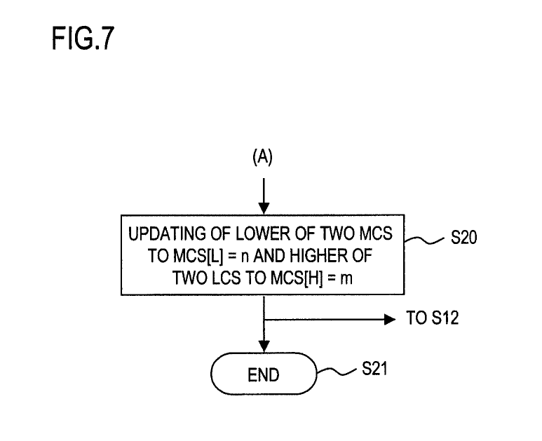

The following provides an example of operation in the present second embodiment. FIGS. 6 and 7 illustrate a flow chart indicating an example of operation in the base station 100. The flow chart illustrated in FIGS. 6 and 7 indicates an example of the operation of MCS burst size determination processing in which assignment of MCS is changed by changing the burst size assigned to two MCS changes in slot units. Furthermore, in the following explanation, the amount of data of a single slot is fixed (for example, to an amount equal to one time unit×48 subcarriers), two burst data assigned to a single user (or single terminal) are selected within a single radio frame, and the total burst size of the two selected burst data is N (wherein, N is an integer of 2 or more, and is equal to the number of slots in the present embodiment).

First, the base station 100 initiates processing (S10), selects the two burst data contained in a single radio frame (see, for example, FIG. 5A), and initially selects an MCS for each burst data. The base station 100 then respectively defines the burst size to be assigned to the two MCS as N/2 (S11).

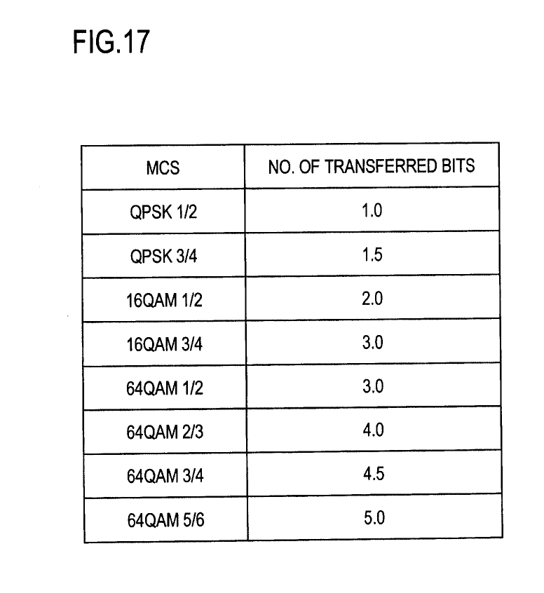

For example, the control unit 110 assigns (or schedules) radio resources to data of a single radio frame output from the transmission data processing unit 102, and selects two burst data assigned to a single user (or single terminal). The control unit 110 then initially selects two MCS based on, for example, a signal-to-noise ratio (SNR) for a reference signal. The initially selected two MCS are the two MCS for which the difference in the number of transferred bits is the smallest, and in the example illustrated in FIG. 17, consist of “QPSK ¾”, “16QAM ½” and the like.

Furthermore, among the two MCS, the MCS having the larger number of transferred bits is referred to as the high MCS while the MCS having the smaller number of transferred bits is referred to as the low MCS, and the burst size of the high MCS is referred to as MCS[H] while the burst size of the low MCS is referred to as MCS[L]. In the processing of S11, the control unit 110 defines, for example, MCS[H]=N/2 and MCS[L]=N/2 (namely, makes the burst size assigned to each MCS to be the same size (same number of slots)).

Here, a reference signal is transmitted from the base station 100, and in the demodulation and decoding unit 203 or the control unit 210 of the terminal 200, for example, SNR is measured for the reference signal and the measured SNR is transmitted to the base station 100. For example, this may also be a received power signal instead of the SNR. The initially selected MCS are based on, for example, the SNR for the reference signal.

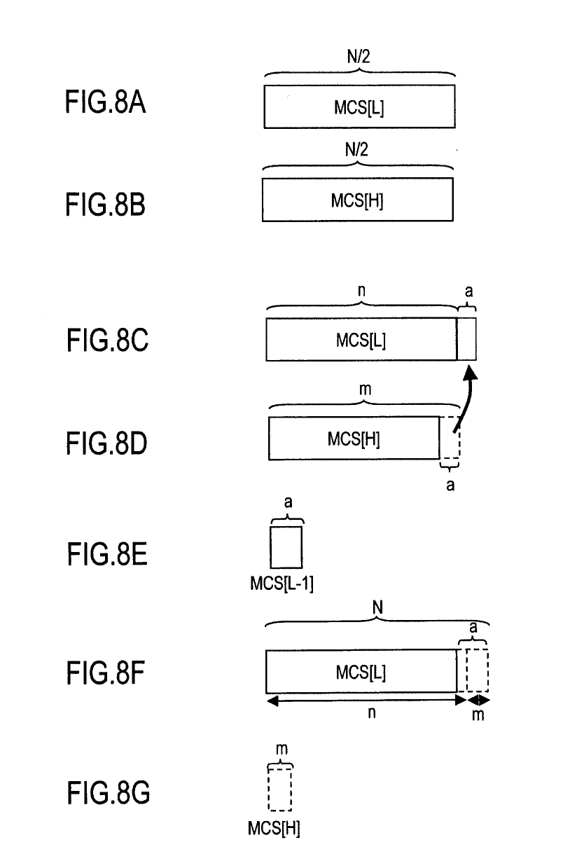

FIGS. 8A and 8B illustrate examples of the burst size assigned to each of the MCS selected in the manner described above. FIG. 8A illustrates an example of the MCS[L], while FIG. 8B illustrates an example of the MCS[H]. As a result of the initial selection, the burst sizes MCS[L] and MCS[H] of the two MCS assigned to a single user are initially of the same size.

The base station 100 then carries out encoding processing and modulation processing based on the two MCS selected in this manner and the burst size assigned to each MCS, and then transmits data to the terminal 200. On the other hand, the terminal 200 receives the data and carries out error detection based on, for example, an error detection code added to the data by the demodulation and decoding unit 203, and then generates an error detection result indicating the presence or absence of an error by carrying out error detection based on an error detection code added to the data. The terminal 200 transmits two error detection results since error detection is carried out on each burst data assigned to the two MCS, for example.

The base station 100 waits for the error detection result transmitted from the terminal 200 (S12), and when that result has been received, carries out internal error assessment processing (S13). For example, the error detection result is converted to a frequency axis signal by the FFT unit 106 via the RF unit 105, subjected to demodulation and decoding processing in the demodulation and decoding unit 107, and then output to the control unit 110 via the received data processing unit 108. The control unit 110 carries out internal error assessment processing when the error detection result has been input.

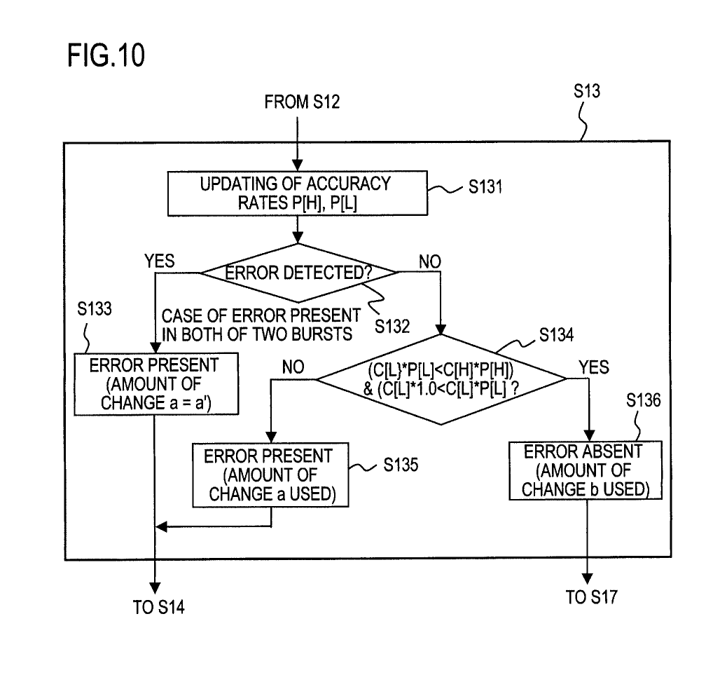

FIG. 10 illustrates a flow chart indicating an example of internal error assessment processing. The internal error assessment processing consists of, for example, assessing for the presence or absence of an error based on the error detection result (S12).

First, the base station 100 proceeds to internal error assessment processing, it updates the accuracy rates P[H] and P[L] of the burst data (S131). The accuracy rate P[H] is, for example, the accuracy rate of burst data corresponding to the high MCS, and can be obtained by:

P[H]=1.0−error rate of burst data according to high MCS (2)

The “error rate of burst data according to high MCS” can employ a value obtained by dividing the number of times an NACK signal is received during a certain time period for burst data transmitted according to the high MCS by the total number of times acknowledgment results (ACK signals and NACK signals) are received during that certain time period. For example, the control unit 110 is able to obtain the accuracy rate P[H] by obtaining an error rate by counting the number of times the NACK signals are received during a prescribed time period and dividing the count value by the total number of times acknowledgment results are received, and then substituting that error rate into formula (2). Alternatively, the control unit 10 can obtain the accuracy rate P[H] by counting the number of ACK signals during a prescribed time period and dividing the count value by the total number of times acknowledgment results are received.

Furthermore, the “error rate of burst data according to high MCS” can also be considered to be, for example, the average NACK signal reception probability (or average error rate) according to the high MCS by counting the number of NACK signals among a prescribed number of (NACK+ACK) and then determining the average. The accuracy rate P[H] can also be considered to be, for example, the average ACK signal reception probability (or accuracy rate) for the high MCS.

On the other hand, the accuracy rate P[L] is, for example, the error rate of burst data according to the low MCS, and can be obtained by:

P[L]=1.0−error rate of burst data according to low MCS (3)

Similar to the accuracy rate P[H], the control unit 110 is able to obtain the rate by, for example, calculating the error rate by counting the number of times NACK signals are received for burst data according to the low MCS during a prescribed time period and dividing the count value by the total number of times acknowledgment results are received within that processing time. By then substituting that error rate into formula (3), the control unit 110 can obtain the accuracy rate P[L]. Alternatively, the control unit 110 can also obtain the accuracy rate P[L] by, for example, counting the number of ACK signals received. For example, the control unit 110 stores the calculated accuracy rates P[H] and P[L] in memory (not illustrated), and then updates those rates if accuracy rates P[H] and P[L] are already stored in memory.

In this case as well, since the “error rate of burst data according to low MCS” takes into consideration a prescribed number of NACK signals, it can also be considered to be the average NACK signal reception probability (or average error rate) for the low MCS. In addition, the accuracy rate P[L] can also be considered to be the average ACK signal reception probability (or accuracy rate) for the low MCS.

Next, the base station 100 determines whether or not a detection result indicating the presence of an error (such as an NACK signal) has been received for both of the two burst data (S132). For example, the control unit 110 determines this according to whether or not error detection results for the two burst data transmitted in the initially selected MCS (S11) are all NACK signals. Since processing is carried out in S131 by acquiring error detection results during a prescribed time period, for example, processing is also carried out in this processing based on error detection results acquired during that prescribed time period.

When the error detection results for the two burst data both indicate an error (YES in S132), the base station 100 obtains an error assessment result indicating that an error is present (S133). For example, the control unit 110 obtains an assessment result indicating the presence of an error when detection results for the two burst data received by the base station 100 (output from the received data processing unit 108) are NACK signals for both prescribed time periods.

At this time, the control unit 110 uses, for example, “a′” as an amount of change a. The amount of change “a′” is predetermined to be, for example, “5 slots”, is retained in memory (not illustrated), and is read from the memory when the control unit 110 has obtained the present error assessment result, resulting in a value of “5” for the amount of change a. This amount of change a is an amount of change when burst size changes. The amount of change a will be subsequently described.

On the other hand, when the error detection results for the two burst data both do not indicate the presence of an error (NO in S132), the base station carries out an error assessment according to an assessment algorithm (S134). For example, when at least one of the two error detection results is an ACK signal or when both are ACK signals, the control unit 110 carries out error assessment according to the assessment algorithm.

When the number of transferred bits for the high MCS is defined as C[H] and the number of transferred bits for the low MCS is defined as C[L], then the assessment algorithm is used to assess error according to whether or not the following are satisfied:

(C[L]×P[L]<C[H]×P[H]), and

(C[L−1]×1.0<C[L]×P[L]) (4)

When this formula (4) is satisfied (YES in S134), the error assessment result indicates the absence of an error (S136), and when this formula (4) is not satisfied (NO in S134), the error assessment result indicates the presence of an error (S135).

In providing an explanation of the formula (4), the number of bits actually transferred (to be referred to as the “average number of transferred bits”) is calculated by multiplying the number of transferred bits (C) by the accuracy rate (P). The average number of transferred bits for burst data transmitted with the low MCS is calculated according to C[L]×P[L], and the average number of transferred bits for the burst data transmitted with the high MCS is calculated according to C[H]×P[H]. The first part of formula (4) indicates that, for example, that the high MCS was actually able to transmit a larger amount of data than the low MCS, and that the high MCS is more effective or valid than the low MCS with respect to MCS selection.

In addition, C[L−1] is used in the latter part of formula (4), and this indicates that a number of transferred bits of an MCS lower than the low MCS (see, for example, FIG. 17) is used. For example, when the low MCS is “QPSK ¾”, C[L−1]=1.0 (MCS is the number of transferred bits of “QPSK ½”). Furthermore, C[L−1]=0 when there is no MCS lower than the low MCS.

The latter part of formula (4) indicates that, for example, the accuracy rate of the low MCS is 100%, and that the average number of transferred bits (C[L]×P[L]) of the low MCS becomes larger than the average number of transferred bits of the lower MCS (C[L−1]×1.0). Namely, the latter part of formula (4) indicates, for example, that the low MCS is more effective than the lower MCS for MCS selection, and that selection of the low MCS is valid.

Accordingly, the base station 100 can also judge that the current MCS may be continued to may be changed to the high MCS when formula (4) is satisfied when transmitting data by selecting the current low MCS (YES in S134). The base station 100 determines that there are no errors present (S136) for the error assessment result when formula (4) is satisfied (YES in S134) in the internal error assessment processing (S13).

Furthermore, in this case, the base station 100 uses “b” for the amount of change. The amount of change “b” in this case is predetermined, and can be determined by, for example, reading from memory (not illustrated) when the control unit 110 carries out this processing. The amount of change “b” will be subsequently described.

On the other hand, when formula (4) is not satisfied (NO in S134), this indicates that the low MCS is more effective for MCS selection than the high MCS, and the base station 100 is able to judge that the MCS may be changed to the low MCS. The base station 100 determines that an error is present (S135) for the error assessment result when formula (4) is not satisfied (NO in S134) in the internal error assessment processing (S13).

Furthermore, in this case, the base station 100 uses “a” for the amount of change. This amount of change “a” is also predetermined for “1 slot”, for example, and the control unit 110 is able to determine the amount of change by reading from memory (not illustrated) during this processing.

When an error is determined to be present as a result of internal error assessment processing, processing proceeds to S14 of FIG. 6, or proceeds to S17 when an error is determined to be absent. For example, the control unit 110 is able to carry out calculation of formula (4) and internal error assessment processing by retaining the formula (4) in memory (not illustrated), reading the formula (4) during the processing of S134, calculating the average number of bits and then substituting into the formula (4).

Returning to FIG. 6, in the case an error is present as a result of internal error assessment processing, the base station 100 determines whether or not MCS[H]≦a (S14). When the base station 100 has assessed that an error is present according to the internal error assessment processing, since the low MCS is more effective as previously described, the base station 100 changes the MCS to the low MCS. This change is carried out by the base station 100 increasing the burst size assigned to the low MCS by the amount of change a (=number of slots), and decreasing the burst size assigned to the high MCS by the amount of change a (S15 to be subsequently described).

However, if the amount of the decrease in burst size (amount of change “a”) is larger than the burst size assigned to the high MCS even after having changed the burst size of each MCS, burst size can no longer be decreased by the amount of change “a” from the MCS[H]. Therefore, a determination is made as to whether or not there is a burst size equal to the amount of the decrease in S14. In the processing of S14, for example, the control unit 110 makes this determination by comparing the MCS[H] generated in S11 (or the MCS[H] generated in S20 to be subsequently described) with the amount of change “a” generated in S133 or S135.

When MCS[H]≦a is not established (NO in S14), the base station 100 changes the burst size to be assigned to the high MCS and the low MCS (S15). This case (NO in S14) indicates, for example, that there is a burst size equal to the amount of the decrease. The change is carried out so that the MCS burst size changes to the low side as previously described. Namely, when MCS[H]=m and MCS[L]=n prior to changing (where, m+n=N), then the base station 100 carries out the change as indicated below:

MCS[L]=m+a (5)

MCS[H]=n−a (6)

FIGS. 8C and 8D illustrate examples of burst size of each MCS after changing. When an assessment result indicating the presence of an error is obtained in internal error assessment processing in this manner, and if the amount of change for the burst size of the MCS is only a change to the low MCS, then the base station 100 assigns a larger amount of burst data to the low MCS by the amount of the change. As a result of making the burst size assigned to the low MCS after changing greater than that prior to changing, the base station 100 is able to increase the probability of ACK signals being transmitted from the terminal 200 in comparison with prior to changing by transferring MCS selection to the low MCS.

Moreover, by making the amount of change a equal to “1 slot”, for example, the amount of change becomes smaller in comparison with the case in which the amount of change of burst size of the low MCS and the high MCS is “100 slots”, for example, thereby avoiding sudden changes in the MCS ratio. Thus, the amount of change a is preferably a small value such as “1” or “2” in comparison with a value of “100”, for example.

With respect to this amount of change “a”, the amount of change when an error is present in both of the two burst data in the internal error assessment processing was designated as a (=a′) (YES in S132, S133). In addition, the amount of change when the assessment algorithm is not satisfied even though there are no errors in either of the two burst data was designated as a (NO in S132, NO in S134). These two amounts of change a, a′ may be made to satisfy, for example, the relationship a′>a. As a result, the amount of change a′ of the burst size of each MCS after changing becomes greater than that of a.

Namely, when there is an error in both of the two burst data in the internal error assessment processing (S13) (YES in S132), MCS selection cannot be said to be valid for either of the burst data. Therefore, by making the amount of change a′ larger than the amount of change a, the base station 100 makes the burst size assigned to the low MCS larger than the case of the amount of change a, and the probability of both being made to not have an error (YES in S132) can be made to be greater than in the case of the amount of change a.

On the other hand, when MCS[H]≦a is satisfied (YES in S14), the base station 100 changes the burst size assigned to each MCS from MCS[H]=m and MCS[L]=n to that indicated below (S16).

MCS[L−1]=a (7)

MCS[L]=N−a (8)

MCS[M]=0 (9)

FIGS. 8(A) to 8 (G) illustrates an example of burst size in each MCS after being changed. In this case, since the amount of change is equal to or less than a (MCS[H]=m≦a) with respect to the burst size MCS[H] (=m) of the high MCS, for example, there is not an adequate burst size in order to be decreased. In this case, the base station 100 sets MCS[H] to 0 (see, for example, FIG. 8G), and decreases the burst size MCS[L] of the low MCS by the amount of change a from the total N of the two burst sizes (see, for example, FIG. 8F). Moreover, the base station 100 assigns the amount of change a to the burst size MCS[L−1] of a lower MCS (see, for example, FIG. 8E). In such a case, since burst data is assigned to the MCS[L−1], the burst sizes assigned to the low MCS (MCS[L] and MCS[L−1]) after changing become greater than that prior to changing.

In the case an error is indicated to be present in internal error assessment processing, it is more effective to select the low MCS, and since the burst size of the low MCS after becomes greater than that prior to changing due to the change carried out in S16, the probability of an ACK signal being transmitted from the terminal 200 can be increased as compared with prior to changing.

In addition, the amount of change of the burst size MCS[L] of the low MCS is “a−n”, and the amount of change of the burst size MCS[L−1] of a lower MCS is “a”. As a result of decreasing the amount of change “a′” to “1 slot” or “2 slots”, for example, in comparison with the case of “100 slots”, for example, both amounts of change “a−n” and “a” also become smaller in comparison with such case. Accordingly, the probability of occurrence of a burst error PER in the burst sizes MCS[L] and MCS[L−1] after changing can also be decreased in comparison with the case of making the amount of change “100 slots”, for example. Since the amount of the decrease “m” from the MCS[H] is smaller than the amount of change “a”, the probability of the occurrence of a burst error in the MCS[H] after changing also becomes lower than that of the MCS[L−1]. Accordingly, even if the MCS is changed to the low MCS in this manner, the probability of receiving an ACK signal from the terminal 200 can be increased more than in the case of setting the amount of change “a” to “100 slots”. Throughput can therefore be improved.

Furthermore, the processing of S15 and S16 is carried out by the control unit 110, for example. For example, the control unit 110 can carry out this processing by retaining MCS[L−1] to MCS[H] in memory (not illustrated), and changing by the amount of change “a” (formulas (6) to (9)) obtained in S133 and S135.

Following completion of S15 and S16, the base station 100 updates the lower of the two MCS burst sizes after changing to MCS[L]=m and updates the higher of the two to MCS[H]=n (S20 in FIG. 7). For example, with respect to formulas (5) and (6), the control unit 110 updates the MCS[L−1] to MCS[H] stored in memory (not illustrated) so that MCS[L]=n+a becomes n and so that MCH[H]=m-a becomes m. In addition, with respect to formulas (7) to (9), the control unit 110 updates so that MCS[L]=a (MCS[L−1] in FIG. 7)=n, and so that MCS[H]=N−a (MCS[L] in FIG. 8)=m.

This series of processing then ends (S21). However, processing can again proceed to S12 and repeat processing for updating burst size multiple times.

On the other hand, when an assessment result indicating the absence of an error has been obtained in the internal error assessment processing (S13), the base station 100 determines whether or not MCS[L]≦b is satisfied (S17). The assessment result indicating the absence of an error in the internal error assessment processing indicates that MCS can be changed to the high MCS (or maintained in its current state) as previously described. In this case, the burst size MCS[L] of the low MCS after changing is decreased by the amount of change “b” as compared with prior to changing, and the amount of change “b” is added to the burst size MCH[H] of the high MCS.

However, even if burst sizes of the MCS are changed, it is no longer possible to decrease MCS[L] by the amount of change “b” if the amount of change “b” is larger than the burst size MCS[L] assigned to the low MCS. Therefore, a determination is made in S17 as to whether or not there is an adequate burst size that enables the burst size to be decreased. In this processing, the control unit 110 makes this determination by comparing the MCS[H] generated in S11 (or the MCS[H] generated in S20) with the amount of change “b” generated in S136.

When MCS[L]≦“b” is not satisfied (NO in S17), the base station 100 decreases MCS[L] by the amount of change “b” and adds the amount of change “b” to MCS[H] as previously described so that the burst size MCS[L] of the low MCS has an adequate size that can be decreased by the amount of change “b” (S18). Namely, the base station 100 respectively changes the burst sizes MCS[L]=n and MCS[H]=m prior to changing to those indicated below.

MCS[L]=n−b (10)

MCS[H]=m+b (11)

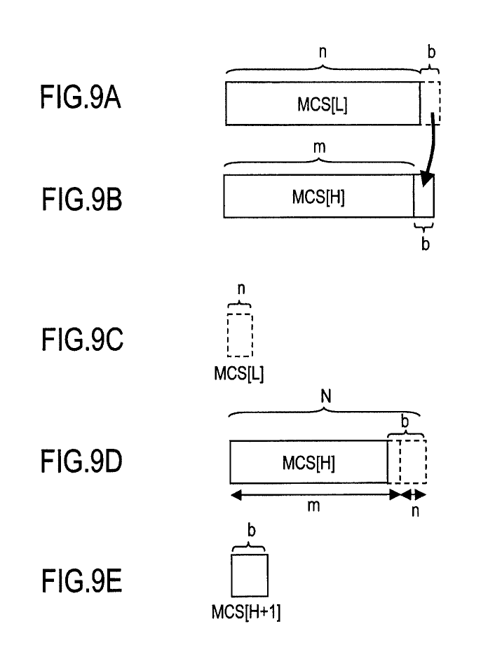

FIGS. 9A and 9B respectively illustrate examples of the burst size of each MCS after changing. In this case, the absence of an error is assessed in the internal error assessment processing (S13), and formula (4) is satisfied in the assessment algorithm (S134). Namely, in this case, selection of the high MCS results in a higher accuracy rate than selection of the low MCS. Accordingly, by increasing the MCS[H] after changing as compared with before changing, the burst size of the high MCS from the terminal 200 becomes larger than before changing and throughput is improved.

In addition, since the amount of change “b” of the burst sizes MCS[L] and MCS[H] assigned to the high MCS is made to be “1 slot” and the like, in comparison with the case of “100 slots”, for example, the amount of change can be decreased. In this case, due to the small amount of change, the probability of the occurrence of a burst error PER is lower than in the case of “100 slots”. Accordingly, even if the MCS is changed to the high MCS, the probability of receiving an ACK signal from the terminal 200 can be increased in comparison with the case of “100 slots”, and throughput can be improved. The amount of change “b” is preferably as small a value as possible, such as “1 slot” or “2 slots”, for example.

On the other hand, when MCS[L]≦b is satisfied (YES in S17), the base station 100 is unable to decrease the burst size MCS[L] of the low MCS by the amount of change “b”. In this case, the base station 100 respectively changes the burst sizes MCS[L]=n and MCS[H]=m of each MCS to that indicated below (S19).

MCS[L]=0 (12)

MCS[H]=N−b (13)

MCS[H+1]=b (14)

FIGS. 9C to 9E respectively illustrate examples of each MCS burst size after changing. In this case as well, similar to the case of S18, as a result of increasing MCS[H] and MCS[H+1] after changing as compared with before changing, burst size of the high MCS from the terminal 200 becomes larger as compared with before changing and throughput is improved.

In addition, the amount of change of the burst size MCS[H] of the high MCS is “N−b”, while the burst size MCH[H+1] of a higher MCS is “b”. As a result of making the amount of change “b” to smaller than “100 slots”, for example, such as “1 slot” or “2 slots”, the amounts of change “N−b” and “b” are also smaller in comparison with such a case. Accordingly, the probability of the occurrence of a burst error PER for the MCS[H] after changing can be lowered as compared with the case of making the amount of change “100 slots” and the like, and even if the MCS is changed to the high MCS, the probability of receiving an ACK signal from the terminal 200 can be made to be nearly equal to that of such a case. Thus, throughput can be improved.

The processing of S18 and S19 is carried out by the control unit 110. For example, the control unit 110 calculates MCS[L] to MCS[H+1] by retaining the MCS[L] to MCS[H+1] and formulas (10) to (14) in memory (not illustrated), and calculating formulas (10) to (14) based on the amount of change “b” obtained in S126.

After having carried out the processing of S18 and S19, the base station 100 updates the lower of the two MCS burst sizes after changing to MCS[L]=m and updates the higher of the two to MCS[H]=n (S20 in FIG. 7). For example, the control unit 110 updates the MCS[L] to MCS[H+1] stored in memory (not illustrated) so that MCS[L]=n−b becomes n and so that MCH[H]=m+b becomes m, or updates so that MCS[L]=N−b becomes n and MCS[H]=b becomes m.

The base station 100 completes this series of processing (S21), or proceeds to processing S12 and the above-mentioned processing is repeated.

### Other Operation Example 1

The following provides an explanation of another operation example. The previous operation example was explained by making the total burst size N assigned to the two MCS constant. For example, when two burst data have been selected in a radio frame, even if the total size thereof is taken to be N, when two other burst sizes are selected, the total size may be that other than N. The following provides an explanation of an example of such a case in which the total burst size N varies.

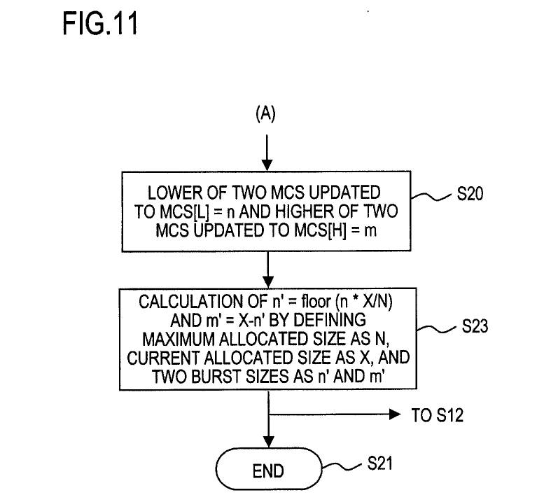

FIG. 11 illustrates a flow chart indicating an operation example in such a case. An explanation is provided of the case in which, for example, after defining the total size N to be the maximum assigned size and calculating this maximum assigned size using the size N, the total size of two burst data is changed resulting in a total size X (≧2). The sizes MCS[L] and MCS[H] of the two burst data in the case the total size of the two burst data is X (for example, the number of slots in this example as well) are designated as n′ and m′, respectively.

Since the sizes MCS[L] and MCS[H] of the two burst data are calculated using the maximum assigned size N (S20), burst sizes MCS[L] and MCS[H] corresponding to the maximum assigned size X after changing can be obtained by changing these burst data sizes.

Namely, the base station 100 calculates the two burst sizes MCS[L] and MCS[H] corresponding to the maximum assigned size N in the manner indicated below (S23) after respectively designating as n and m (S20).

MCS[L]=n′=Floor(n×X/N) (15)

MCS[H]=m′=X−n′ (16)

The burst size n′ of the low MCS corresponding to the maximum assigned size N is calculated by multiplying the ratio (X/N) of the assigned size X to the maximum assigned size N by the burst size n of the low MCS according to formula (15). In formula (15), n′=1 when n′=0 and n′=X−1 when n′=X in consideration of fractions. Subsequently, in the case of repeating processing, two burst sizes corresponding to the assigned size X can be changed and determined by carrying out the processing of S12 to S20 using n′ for n and m′ for m.

Conversely, in the case the assigned size X is changed to the maximum assigned size N, the base station 100 is able to calculate n and m (=N−n) by carrying out the reverse calculations of formulas (15) and (16) in S23, after which processing (S12 to S20) is carried out using these n and m. In addition to these reverse calculations, the previously calculated n and m may be stored in memory (not illustrated), for example, after which they may be used again.

Even in cases in which the total N of two burst sizes varies in this manner, since processing can be carried out in the same manner as in the previously described example, throughput can be improved by changing to the high MCS or the low MCS. In addition, even if MCS burst size is changed, by making the amounts of change a and b “1 slot”, for example, PER can be decreased in comparison with the case of using “100 slots” and the like for the amount of change. Accordingly, the probability of an ACK signal being transmitted from the terminal 200 increases in comparison with the case of making the amount of change “100 slots” and the like, and the radio communication system 10 is able to improve throughput.

### Other Operation Example 2

Next, an explanation is provided of a second example of other operation. The initially described Operation Example and the subsequently described Other Operation Example 1 described the case of selecting a higher MCS (assigning to MCS[H+1] in S19) or selecting a lower MCS (assigning to MCS[L−1] in S16). At this time, two MCS were present that had the same number of transferred bits. Examples of these MCS include “16QAM ¾” and “64QAM ½”. In such a case, either one of these (for example, “16QAM ¾”) was selected in the previously described Operation Example and Other Operation Example 1.

Typically, in the case of an environment in which the radio link consists of noise only, an MCS of “16QAM ¾”, for example, allows the obtaining of better characteristics than an MCS of “64QAM ½”. On the other hand, in consideration of phasing attributable to movement and the like, “64QAM ½”, for example, allows the obtaining of better characteristics than “16QAM ¾” in an environment in which there is little noise. Which MCS is optimum depends on the environment. This operation example indicates an example processing for selecting a single MCS corresponding to the environment in the case a plurality of MCS are present that have the same number of transferred bits.

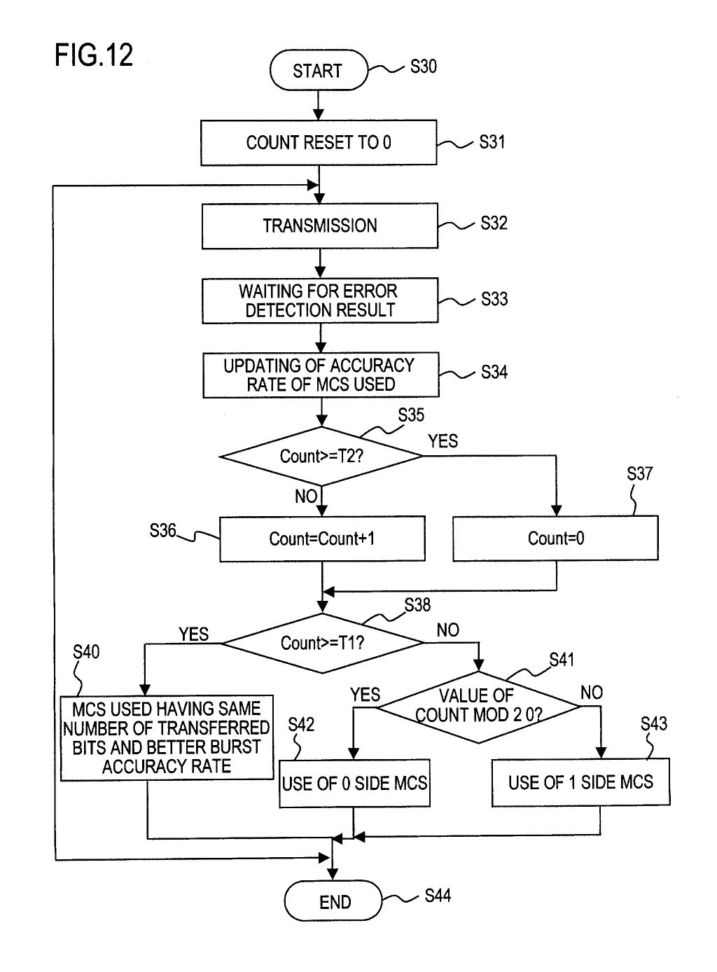

FIG. 12 illustrates a flow chart indicating an operation example of MCS selection processing. For example, the MCS burst size determination processing (FIGS. 6 and 7) is started in the case two MCS have been selected that have the same number of transferred bits when burst data is assigned to a lower MCS and a higher MCS (S16 or S19). For example, after this MCS selection processing has started, processing may be carried out in parallel with the MCS burst size determination processing.

When the base station 100 starts this processing (S30), it resets the count to “0” (S31). This count is a value for counting time periods, and is counted by, for example, the control unit 110.

Next, the base station 100 transmits burst data according to the selected MCS (S32). Since either MCS used in processing to be subsequently described (S42, S43 or S40) is selected by this processing, burst data is transmitted using the MCS selected by this processing. For example, burst data is transmitted by selection of the MCS by the control unit 110 followed by output to the modulation and encoding unit 103 as control information.

Next, the base station 100 waits for the reception of an error detection result for the transmitted burst data (S33), and when an error detection result is received, updates the accurate rate of the MCS used (S34). For example, when an error detection result is received, the control unit 110 is able to calculate the accuracy rate of the MCS used by calculating the error rate P by dividing the number of times an NACK signal is received by the total number of times error detection results are received and calculating (1-P). The control unit 110 then, for example, retains the accuracy rate of each MCS in memory (not illustrated), and updates accuracy rates in the case of having previously retained accuracy rates in the memory. For example, the accuracy rate P is the average reception probability of NACK signals for the MCS used, and the accuracy rate is also the average reception probability of ACK signals for the MCS used.

Next, the base station 100 determines whether or not the count is equal to or greater than T2 (S35). Although MCS are alternately selected in processing to be subsequently described (S42 and S43), this T2 indicates a trial period for alternately selecting the MCS, for example. For example, the control unit 110 makes this determination by comparing the count retained in memory (not illustrated) with T2.

When the count is less than T2 (NO in S35), the base station 100 increments the count by “1” (S36), and when the count is equal to or greater than T2 (YES in S35), resets the count to “0” (S36). When the count is less than T2, the base station 100 increments the count by “1” as a trial period, and when the count exceeds T2, resets to the count to “0” and is again within the trial period.

When the processing of S36 and S37 is completed, the base station 100 determines whether or not the count is equal to or greater than T1 (S38), and when the count is equal to or greater than T1 (YES in S38), selects and uses the MCS having the higher accuracy rate (S40). On the other hand, when the count is less than T1 (NO in S38), the base station 100 proceeds to the processing of S41. Here, when the count is equal to or greater than T1 (YES in S38), the alternating selection and use of MCS (S42 and S43) is discontinued, and the MCS having the better accuracy rate is selected and used based on the accuracy rates of the updated MCS (S40). For example, the control unit 110 makes this determination by comparing a count retained in memory (not illustrated) with T1, selects the MCS having the better accuracy rate based on the accuracy rate or each MCS retained in memory, and then outputs that result to the modulation and encoding unit 103 as control information.

In the processing of S41, the base station 100 divides the count by “2” and determines whether or not the remainder is “0” (S41). When the remainder is “0” (YES in S41), the base station 100 selects and uses the 0 side MCS (one of the two MCS) (S42), and when the remainder is not “0” (NO in S41), uses and selects the 1 side MCS (other of the two MCS) (S43). Here, processing is carried out in which, for example, MCS are alternately selected and used according to the current count. For example, this processing is carried out by the control unit 110 selecting one of the MCS based on the remainder resulting from dividing the count by “2”, and then outputting the selected MCS to the modulating and encoding unit 103 as control information.

In providing an overall explanation of this MCS selection processing, when the count is less than T2 (S35), the base station 100 sequentially increments the count by “1”, and alternately selects and uses MCS until the count reaches T1 (S42, S43). When the count reaches T1 (YES in S38), the base station 100 selects and uses the MCS having the better accuracy rate (S40). The base station 100 then continues to use that MCS until the count for the MCS having the better accuracy rate reaches T2 (NO in S35), and when the count reaches T2, resets the count as again being within the trial period (YES in S35, S37). Subsequently, the base station 100 again alternately selects and uses MCS (S42, S43).

Since MCS are selected in consideration of accuracy rates in the case of actually using the MCS in this manner, for example, MCS can be selected in consideration of the actual environment of the radio link between the base station 100 and the terminal 200.

### Other Embodiment

The following provides an explanation of another embodiment. In the previously described first and second embodiments, explanations were provided of the radio communication system 10 between the base station 100 and the terminal 200. The present invention can also be applied to the radio communication system 10 that mutually carries out radio communication between the terminals 200 without going through the base station 100 in the manner of a radio LAN and the like.

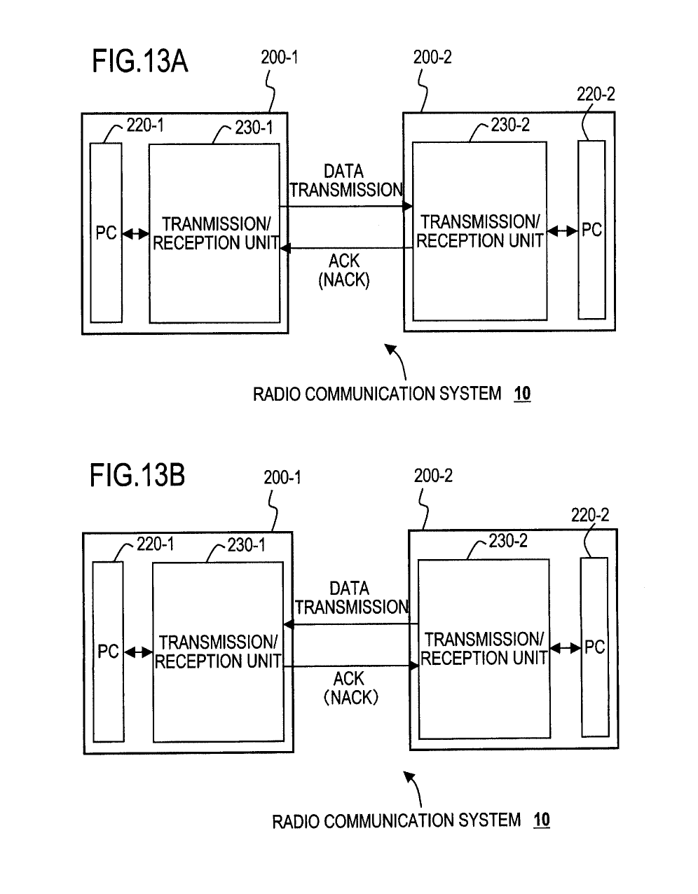

FIGS. 13A and 13B illustrate an example of the configuration of the radio communication system 10 in such a case. In this radio communication system 10, the terminals 200-1 and 200-2 mutually carry out radio communication directly. In this radio communication system 10, the authority to determine selection of MCS lies with the terminals 200-1 and 200-2 that transmit data.

Thus, in the case the terminal 200-1 transmits data, the terminal 200-1 carries out MCS burst size determination processing (see, for example, FIGS. 6, 7 and 11), internal error assessment processing (see, for example, FIG. 10) and MCS selection processing (see, for example, FIG. 12) based on an ACK signal (or NACK signal) transmitted from the terminal 200-2.

The terminal 200-1 is provided with a PC 220-1 and a transmission/reception unit 230-1. The PC 220-1 is the same as the PC 220 of the second embodiment, and the transmission/reception unit 230-1 is provided each of the units 201 to 210 (see, for example, FIG. 4) of the terminal 200. For example, the control unit 210 within the transmission/reception unit 230-1 carries out MCS burst size determination processing, internal error assessment processing or MCS selection processing in the same manner as the control unit 110 of the base station 100 in the second embodiment.

In addition, in the case the terminal 200-2 transmits data, the terminal 200-2 carries out MCS burst size determination processing and the like based on an ACK signal (or NACK signal) transmitted from the terminal 200-1. The terminal 200-2 is also provided with a PC 220-2 and a transmission/reception unit 230-2, and the transmission/reception unit 230-2 is provided with each of the units 201 to 210 of the terminal 200. For example, the control unit 210 carries out MCS burst size determination processing, internal error assessment processing or MCS selection processing in the same manner as the control unit 110 of the base station 100 in the second embodiment.

Furthermore, the terminals 200-1 and 200-2 per se in FIGS. 13A and 13B may also be PC. In this case, the PC 220-1 and 220-2 are not required to be provided therein.

In this manner, in the radio communication system 10 of the present embodiment as well, various types of processing such as burst size determination processing can be carried out in the terminals 200-1 and 200-2 that transmit data. Thus, since the burst size assigned to MCS is changed based on error detection results in the terminals 200-1 and 200-2 that transmit data, throughput can be improved. In addition, even in the case of changing the burst size of each MCS, as a result of changing the burst size in units of “1 slot”, for example, the probability of the occurrence of burst errors can be reduced, thereby also making it possible to improve throughput.

In addition, the above-mentioned embodiments have been explained for the case of slots being used for the units of the amount of change for the burst size of each MCS. The units may also be bits, subcarriers, symbols or subframes and the like instead of slots.

Moreover, the above-mentioned embodiments have been explained using the example in which the base station 100 selects two burst data among burst data assigned to a single user, and then selects two MCS corresponding to the two burst data. For example, the base station 100 may also carry out processing so as to select three or more burst data and then select three or more MCS corresponding to the burst data. For example, with respect to three MCS, the base station 100 is able to carry out processing (S10 to S20) by designating each burst size as MCS[H], MCS[M] and MCS[L], and then increasing or decreasing the amount of change for each size. In addition, the base station can also be to made to suitably carry out assignment of burst data for burst sizes MCS[H+1] and MCS[L−1] with respect to a lower MCS and a higher MCS (such as S16 and S19).

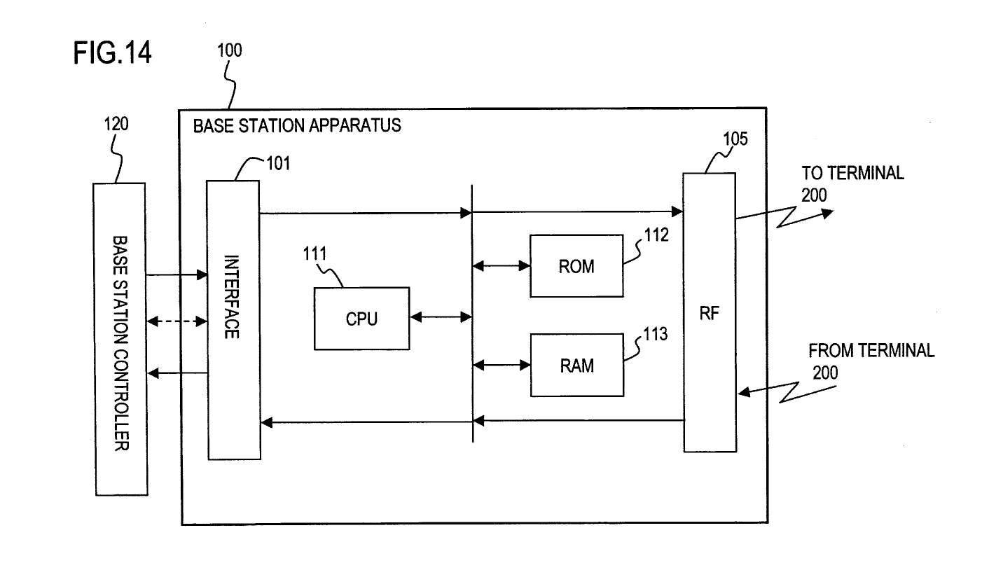

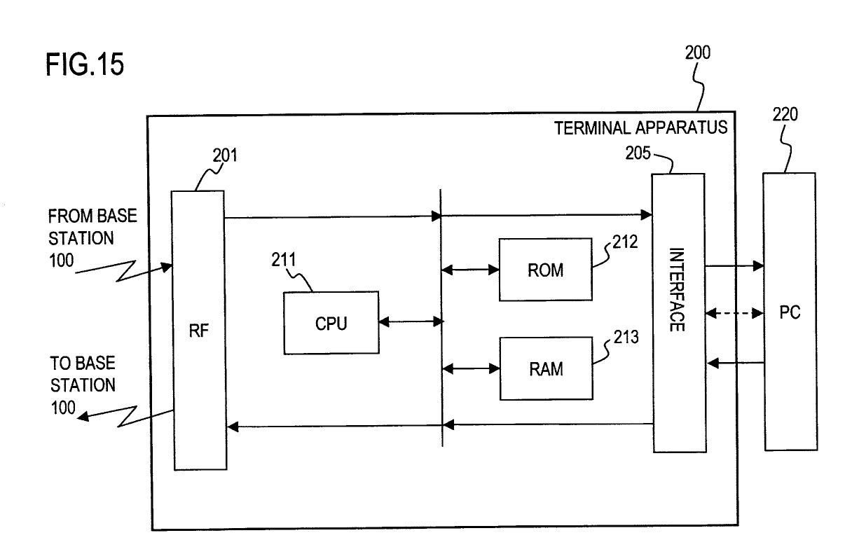

Moreover, in the above-mentioned embodiments, other examples of configurations can be employed for the base station 100 and the terminal 200. FIGS. 14 and 15 respectively illustrate other examples of the configurations of the base station 100 and the terminal 200.

The base station 100 is provided with a central processing unit (CPU) 111, a read only memory (ROM) 112 and a random access memory (RAM) 113. For example, the CPU 111 reads out and executes a program stored in the ROM 112, and suitably stores values or data and the like in the RAM 113 or reads out stored values and the like from the RAM 113 either during or after that execution. In this manner, each of the functions of, for example, the transmission data processing unit 102, the modulating and encoding unit 103, the IFFT unit 104, the FFT unit 106, the demodulation and decoding unit 107 and the received data processing unit 108 in the second embodiment can be realized through coordinated operation of the CPU 111, the ROM 112 and the RAM 113. In this case, the CPU 111 corresponds to, for example, the control unit 110. Moreover, the CPU 111 corresponds to the control unit 170 of the first embodiment, and is able to realize the function of the transmission unit 171 through coordinated operation of the CPU 111, the ROM 112 and the RAM 113.

In addition, the terminal 200 is further provided with a CPU 211, a ROM 212 and a RAM 213. In this case as well, for example, the CPU 211 reads out and executes a program stored in the ROM 212, and suitably stores values or data and the like in the RAM 213 or reads out stored values and the like from the RAM 213 either during or after that execution. In this manner, for example, each of the functions of FFT unit 202, the demodulation and decoding unit 203, the received data processing unit 204, the transmission data processing unit 206, the modulation and encoding unit 207 and the IFFT unit 208 of the second embodiment can be realized through coordinated operation of the CPU 211, the ROM 212 and the RAM 213. In this case, the CPU 211 corresponds to the control unit 210, for example. Moreover, each of the functions of the transmission unit 270 and the reception unit 271 of the first embodiment, for example, can be realize through coordinated operation of the CPU 211, the ROM 212 and the RAM 213.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has been described in detail, it should be understood that the various changes, substitutions, and alterations could be made hereto without departing from the spirit and scope of the invention.

What is claimed is:

1. A radio communication apparatus for performing radio communication with an other radio communication apparatus, the radio communication apparatus comprising:
a control unit which determines an encoding rate, a modulation scheme, and data volume for each of a plurality of transmission data transmitted to the other radio communication apparatus based on an error detection result received from the other radio communication apparatus; and
a transmission unit which respectively transmits the plurality of transmission data to the other radio communication apparatus based on the determined encoding rate, modulation scheme, and data volume.

2. The radio communication apparatus according to claim 1, wherein the data volume for each of the plurality of transmission data is determined by changing the data volume for each of the plurality of transmission data.

3. The radio communication apparatus according to claim 1, wherein the total data volume for each of the plurality of transmission data is variable.

4. The radio communication apparatus according to claim 1, wherein the control unit determines the encoding rate and the modulation scheme based on an average error rate indicating an average reception probability of the error detection result indicating the presence of an error, or an average accuracy rate indicating an average reception probability of the error detection result indicating the absence of an error.

5. The radio communication apparatus according to claim 1, wherein the control unit determines an encoding rate and modulation scheme by selecting either the encoding rate or modulation scheme, for each of two encoding rates and modulation schemes having the same number of transferred bits per subcarrier, based on an average error rate indicating an average reception probability of the error detection result indicating the presence of an error, or an average accuracy rate indicating the average reception probability of the error detection result indicating the absence of an error.

6. The radio communication apparatus according to claim 2, wherein the control unit changes the data volume by radio resource formed of a single time and a plurality of subcarriers.

7. The radio communication apparatus according to claim 6, wherein the radio resource is a slot.

8. The radio communication apparatus according to claim 1, wherein the transmission unit add an one error detection code to each of the plurality of transmission data and transmits.

9. The radio communication apparatus according to claim 4, wherein the control unit determines encoding rate, modulation scheme, and data volume for each of the plurality of transmission data by assigning data volume of the transmission data to each of the plurality of encoding rates and modulation schemes based on the average error rate or the average accuracy rate.

10. The radio communication apparatus according to claim 9, wherein the control unit decreases the data volume assigned to first encoding rate and modulation scheme by an amount of change, and increases the data volume assigned to the second encoding rate and modulation scheme by the amount of change, when the detection result is obtained indicating that an error is present in all of the transmission data transmitted according to first and second encoding rates and modulation schemes among the plurality of encoding rates and modulation schemes, or when the error detection result is obtained indicating that an error is not present in at least one of the transmission data transmitted according to first or second encoding rates and modulation schemes among the plurality of encoding rates and modulation schemes, and an average number of transferred bits took into consideration the average error rate or the average accuracy rate of the transmission data transmitted according to the first encoding rate and modulation scheme for which the number of transferred bits per subcarrier is greater than that of the second encoding rate and modulation scheme, is not greater than the average number of transferred bits of the transmission data transmitted according to the second encoding rate and modulation scheme.

11. The radio communication apparatus according to claim 10, wherein first amount of change, which is an amount of change when the detection result is obtained indicating the presence of error for all transmission data transmitted according to the first and second encoding rates and modulation schemes, is greater than a second amount of change which is an amount of change when the average number of transferred bits of the transmission data transmitted according to the first encoding rate and modulation scheme is not greater than the average number of transferred bits of the transmission data transmitted according to the second encoding rate and modulation scheme.

12. The radio communication apparatus according to claim 10, wherein the control unit assigns the amount of change as the data volume to third encoding rate and modulation scheme in which the number of transferred bits is lower than that of the second encoding rate and modulation scheme, and assigns the data volume in an amount, obtained by subtracting the amount of change from the total data volume, to the second encoding rate and modulation scheme, when the amount of change is equal to or greater than the data volume assigned to the first encoding rate and modulation scheme.

13. The radio communication apparatus according to claim 9, wherein the control unit decreases the data volume assigned to the second encoding rate and modulation scheme by an amount of change in the volume, and increases the data volume assigned to the first encoding rate and modulation scheme by the amount of change in the volume, when the detection result is obtained indicating that an error is not present in at least one of the transmission data transmitted according to the first or second encoding rates and modulation schemes among the plurality of encoding rates and modulation schemes, and an average number of transferred bits took into consideration the average error rate or the average accuracy rate of the transmission data transmitted according to the first encoding rate and modulation scheme for which the number of transferred bits per subcarrier is greater than that of the second encoding rate and modulation scheme, is greater than the average number of transferred bits of the transmission data transmitted according to the second encoding rate and modulation scheme

14. The radio communication apparatus according to claim 13, wherein the control unit assigns the amount of change as the data volume to fourth encoding rate and modulation scheme in which the number of transferred bits is higher than that of the first encoding rate and modulation scheme, and assigns the data volume in an amount, obtained by subtracting the amount of change from the total data volume, to the first encoding rate and modulation scheme, when the amount of change is equal to or greater than the data volume assigned to the second encoding rate and modulation scheme

15. The radio communication apparatus according to claim 1, wherein the first radio communication apparatus is a base station apparatus, the second radio communication apparatus is a terminal apparatus, or the first and the second radio communication apparatus are terminal apparatus.

16. A radio communication system, comprising:
first radio communication apparatus; and
second radio communication apparatus, wherein
the first radio apparatus and second radio apparatus performs radio communication,
the first radio communication apparatus includes:
a control unit which determines an encoding rate, a modulation scheme and data volume for each of a plurality of transmission data transmitted to the second radio communication apparatus based on an error detection result received from the second radio communication apparatus, and
a transmission unit which respectively transmits the plurality of transmission data to the other radio transmission apparatus based on the determined encoding rate, modulation scheme, and data volume, and
the second radio communication apparatus includes:
a transmission unit which transmits the error detection result, and
a reception unit which receives the plurality of transmission data.

17. A radio communication method in a radio communication apparatus for performing radio communication with an other radio communication apparatus, the method comprising:
determining by a control unit an encoding rate, a modulation scheme, and data volume for each of a plurality of transmission data transmitted to the other radio communication apparatus based on an error detection result received from the other radio communication apparatus; and
transmitting by a transmission unit respectively the plurality of transmission data to the other radio communication apparatus based on the determined encoding rate, modulation scheme, and data volume.
